(19) United States
(12) Patent Application Publication
(10) Pub. No.: US 2003/0025387 A1
(43) Pub. Date: Feb. 6, 2003

(54) Apparatus for applying brakes on a towed vehicle

(76) Inventor: Mark Schmeling, Boyden, IA (US)

Correspondence Address: MICHAEL C. GILCHRIST, Dorsey & Whitney LLP, 801 Grand Avenue, Des Moines, IA, 50309, US

(21) Appl. No.: 09/919,708

(22) Filed: Aug. 1, 2001

(51) Int. Cl. B60T 13/00

(52) U.S. Cl. 303/7

(57) ABSTRACT

A supplemental braking system for use on a towed vehicle being towed behind a towing vehicle, especially an automobile being towed behind a motor coach by a tow bar. The supplemental braking system utilizes a vacuum motor to depress the brake pedal in the towed vehicle and thereby apply the brakes on the towed vehicle. The vacuum motor is powered by a vacuum supplied by either the natural vacuum created by the intake of a gas engine of the towing vehicle, or by a separate vacuum pump mounted on the towing vehicle. The same vacuum that is used to provide power to the vacuum motor is also used to supply a vacuum to the vacuum booster on the power brake system of the towed vehicle, thereby permitting much smaller pulling forces to be used in applying the brakes of the towed vehicle. Control valves are provided to selectively apply the brakes of the towed vehicle when the brakes of the towing vehicle are applied. The control valves can be set to only partially apply the brakes on the towed vehicle in the standard braking situation, but to fully apply the brakes in instances where the driver of the towing vehicle is initiating an emergency, or panic, stop or in instances where the towed vehicle has broken away from the towing vehicle.

### FIELD OF INVENTION

This invention relates generally to supplemental braking systems for towed vehicles, and more specifically to an apparatus that utilizes a vacuum motor having a flexible membrane with a mechanical connection to the towed vehicle's brake pedal, to depress the towed vehicle's brake pedal and thereby apply the towed vehicle's brakes.

### BACKGROUND OF THE INVENTION

Recreational vehicles or motor coaches, are a common mode of transportation that are increasing in popularity. Because the motor coaches tend to be large and cumbersome, it is common practice to tow an automobile such as a passenger car, behind the motor coach to use once the motor coach is parked for the evening. However, the brakes on the motor coach are not necessarily large enough to safely stop the motor coach with the added weight of the towed vehicle. For this reason, it is known to provide a supplemental braking system for use with the towed vehicle.

The supplemental braking systems have taken several different forms. One common supplemental braking system employs compressed air to extend a rod in a pneumatic cylinder to push the towed vehicle's brake pedal and thereby employ the towed vehicle's braking system. An example of this type of system is shown in Wittkop et al., U.S. Pat. No. 5,031,729. A disadvantage of these types of systems is that they do not take advantage of the power booster that is included on most automobile braking systems. Therefore, the supplemental braking systems that utilize compressed air with pneumatic pistons, typically must press much harder on the brake pedal than is required when the towed vehicle is operational. This creates unnecessary stress and fatigue on the brake components. Furthermore, the compressed air-type supplemental braking systems tend to apply the brakes on a towed vehicle quite abruptly.

Another common type of supplemental braking system is a serge brake system. A serge brake system uses the relative pushing force of the momentum of the towed vehicle against the towing vehicle as the towing vehicle slows to apply the brakes of the towed vehicle. A disadvantage of these type of systems is that they do not apply the towed vehicle's brakes until after the towing vehicle has slowed enough that the momentum of the towed vehicle begins to push the towing vehicle. It is common for these serge brake type systems to be attached directly into the master cylinder of the towed vehicle. This presents a problem because it can avoid the warranty on the braking system of the towed vehicle.

A common method of towing a vehicle behind a motor coach is through the use of a tow bar. Tow bars are advantageous because they provide a simple, and relatively light weight method of attaching a towed vehicle behind a motor coach. When a tow bar is used, all four wheels of the towed vehicle remain on the pavement just as when in normal use. Therefore, the braking system of the towed vehicle can be utilized to help slow the towed vehicle.

Most vehicles that would be towed behind a motor coach for use after the motor coach is parked are provided with power brakes. The most common power brake system in use today employs a vacuum booster. These vacuum boosters utilize the vacuum created by gasoline engines to amplify the force applied by the driver on the brake pedal. When the engine of the towed vehicle is not running, no vacuum is created, and therefore, the vacuum booster will not provide any amplification to the force applied to the brake pedal. The braking system of the towed vehicle typically will work when the vehicle is off, however, a much greater force must be applied to the brake pedal in order to be effective.

A desirable feature for supplemental braking systems is to provide at least one intermediate level of braking that is less than a maximum application of the towed vehicle's brakes. If the brakes on the towed vehicle are applied with too much force, or to quickly, it can cause the towed vehicle to provide unwanted additional resistance to the motor coach, and will put undue stress on the brakes of the towed vehicle. Furthermore, it can cause the tires on the towed vehicle to lock and go into a skid. On the other hand, in some instances it is desired to fully apply the brakes of the towed vehicle, as for example, in an emergency stop when the driver is attempting to stop the motor coach and towed vehicle as quickly as possible.

In rare instances, it is possible for a towed vehicle to become disengaged from the motor coach during towing. This can be a dangerous phenomenon as the towed vehicle can have a great deal of forward momentum, but will have no one steering it. This phenomenon is known commonly as a break away. It is desirable, and in some cases, required by law, for such a break away vehicle to have its brakes applied automatically to bring the break away vehicle to a quick stop.

U.S. Pat. No. 6,152,544 describes a supplemental braking system that takes advantage of the vacuum booster of the brakes of the towed vehicle. This system utilizes a pneumatic piston that retracks a cable attached to the brake pedal of the towed vehicle to pull rather than push the brake pedal of the towed vehicle. Furthermore, it utilizes a remote vacuum source, either in the form of the natural vacuum created by the motor of the motor coach, or by a separate vacuum pump, to provide vacuum to the vacuum booster of the towed vehicle's braking system, and to provide the power for the pneumatic cylinder. This system provides only one level of braking power. Furthermore, pneumatic cylinders can be susceptible to leaks and other difficulties that are not desirable.

The present invention overcomes many of the difficulties associated with the prior supplemental braking systems.

### SUMMARY OF THE INVENTION

The present invention is directed to an apparatus for applying the brakes on a towed vehicle being pulled by a towing vehicle. The towed vehicle being of the type having a self-contained braking system that is activated by depressing a brake pedal. The towing vehicle has a source for supplying a vacuum. A vacuum motor having a flexible membrane movable by application of a vacuum is connected to the vacuum source in the towing vehicle through a pneumatic circuit. The flexible membrane in the vacuum motor is mechanically connected with the brake pedal in the towed vehicle such that as the membrane moves from a rest position towards a fully activated position, through the application of a vacuum through the vacuum motor, the brake pedal in the towed vehicle is depressed, thereby applying the towed vehicle's brakes. The pneumatic circuit includes a control valve which has an activated position that completes a pneumatic circuit between the vacuum source in the towing vehicle and the vacuum motor. The control valve also has a deactivated position wherein the vacuum source is diverted from the vacuum motor. A means is provided for selectively moving the control valve between the activated and deactivated positions.

The primary objective of the present invention is to provide a supplemental braking system for a towed vehicle that utilizes a vacuum motor with a flexible membrane to selectively apply the brakes of the towed vehicle.

### BRIEF DESCRIPTION OF THE DRAWINGS

FIG. 1 is a schematic of the pneumatic and electrical components of the present invention;

FIG. 2 is a detailed drawing of a preferred embodiment of a vacuum motor for use in conjunction with the present invention;

FIG. 3 is a detailed drawing showing the pneumatic components of a preferred embodiment of the present invention;

FIG. 4 is a detailed view of a panic switch for use in association with the present invention

FIG. 5 is a detailed view of panic switch of FIG. 4, as it is installed with a leveling device; and

FIG. 6 is a detailed view of the mounting bracket, vacuum motor, and brake pedal pulling wire according to a preferred embodiment of the present invention.

### DETAILED DESCRIPTION OF THE INVENTION

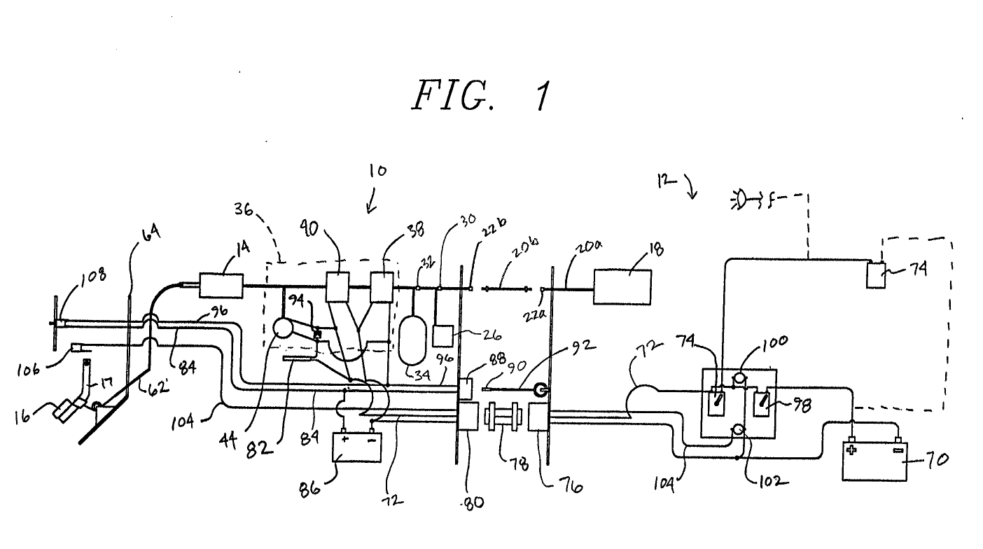

Shown generally in the drawings is a system for applying the brakes on a towed vehicle 10 that is being pulled by a towing vehicle 12. The system comprises mechanical and pneumatic components, including a vacuum motor 14 that is attached to a brake pedal 16 of the towed vehicle 10, and electrical components. When the appropriate electrical signal is sent, the vacuum motor 14 pulls the brake pedal 16 to apply the brakes of the towed vehicle 10. FIG. 1 shows a symbolic schematic of the electrical and pneumatic components of the system.

Starting at the towing vehicle 12, and working back towards the brake pedal 16, the mechanical and pneumatic components can be described as follows. A vacuum source 18 is provided on the towing vehicle 12. If the towing vehicle 12 has a gas engine, the vacuum source is preferably the intake manifold of the gas engine. If the towing vehicle has a diesel engine, a separate vacuum pump should be mounted in the towing vehicle. Typically a vacuum of about 21 inches of mercury is sufficient to provide the necessary vacuum force. An air hose 20a runs from the vacuum source 18 to the rear of the towing vehicle 12, where it is preferably provided with a quick connect coupling 22a. Another air hose 20b connects the quick connect coupling 22a at the rear of the towing vehicle with a quick connect coupling 22b at the front of the towed vehicle 10.

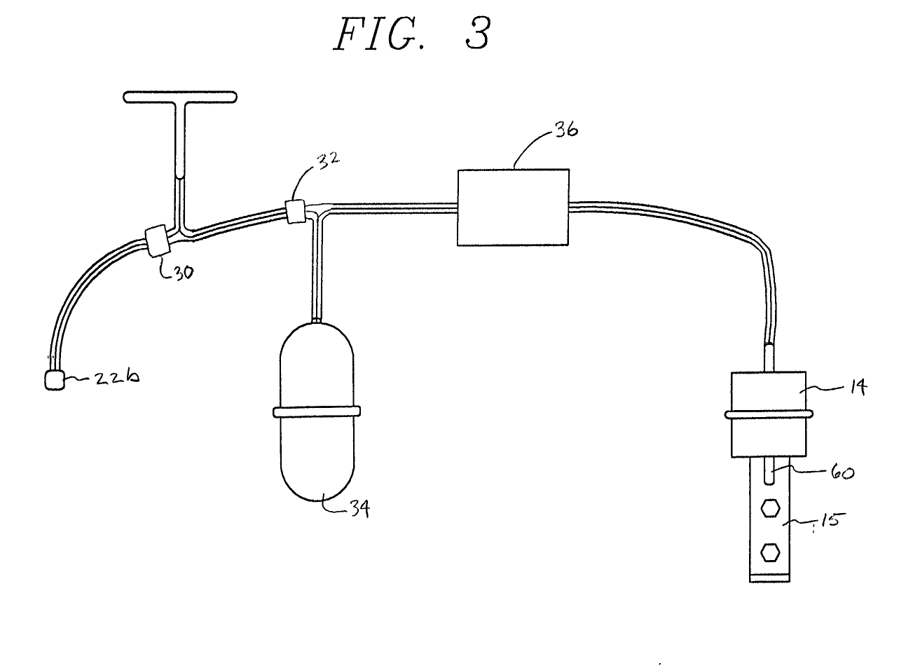

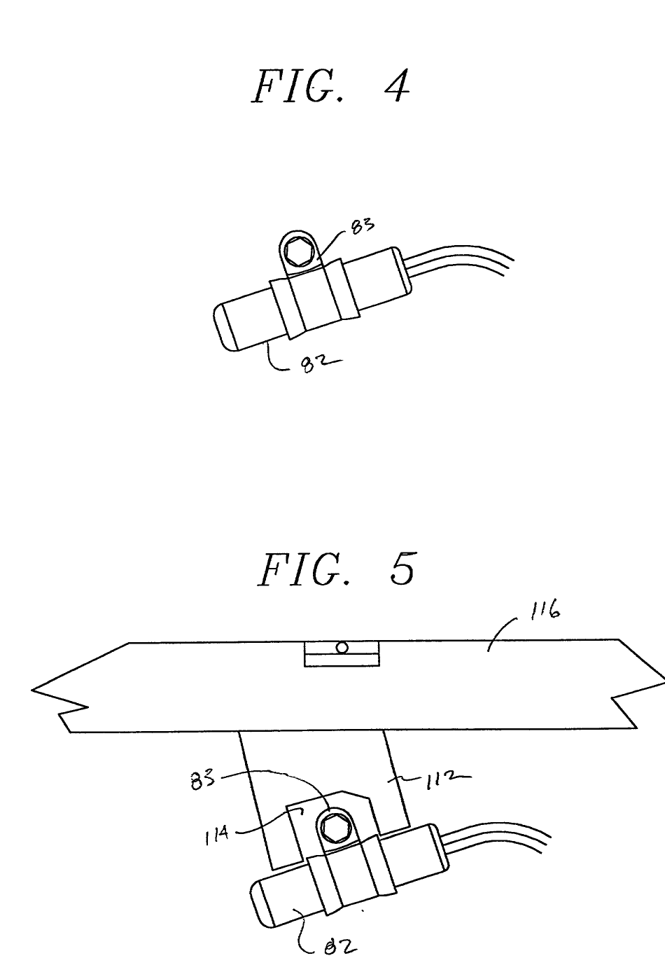

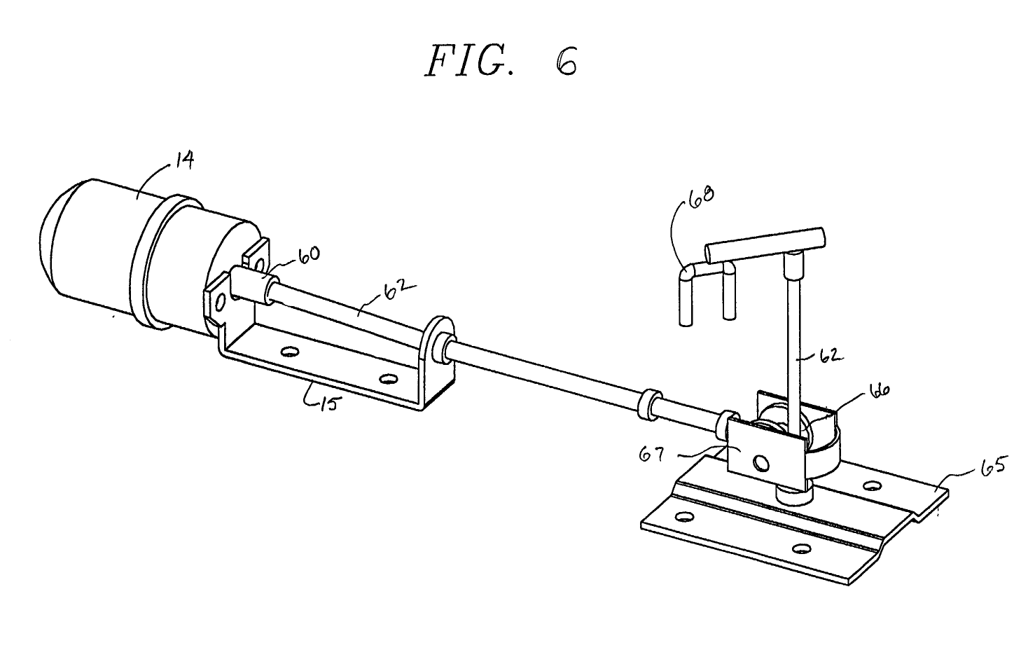

A pneumatic circuit 24 connects the quick connect coupling 22b at the front of the towed vehicle 10 with the vacuum motor 14. The basic components of the pneumatic circuit can be seen in FIG. 3. An air hose connects the quick connect coupling 22b with the brake booster 26 of the towed vehicle 10. In practice this is preferably done by removing the brake booster supply line of the towed vehicle 10 and replacing it with a T-connection 28. This is done because some brake booster supply lines are provided with a check valve that can cause difficulties. A first check valve 30 is provided between the inlet port 22b and the T-connection so that air can flow from the brake booster 26 towards the vacuum source 18, but cannot flow in the opposite direction. A vacuum reservoir 34, typically an accumulator, is connected to the pneumatic circuit 24 on the vacuum motor side of the brake booster 26. The vacuum reservoir 34 provides vacuum to the brake booster 26, in case the pneumatic circuit 24 comes disconnected from the vacuum source 18. A second check valve 32 is provided between the vacuum reservoir 34 and the brake booster 26, which permits air to flow towards the vacuum source, but prevents air from flowing in the opposite direction.

The pneumatic circuit 24 then runs through a control box 36. The control box includes two control valves 38, 40 in series with each other. The first control valve 38 regulates the pressure level applied to the vacuum motor 14. The second control valve 40 acts as an on-off valve. Both of the control valves 38, 40 are two-position, three-way valves that are normally in a deactivated position. When they are energized, they move to an activated position to complete the circuit so that air can flow from the vacuum motor 14 towards the vacuum source 18. The first control valve 38 has its exhaust port closed, so that atmospheric pressure air cannot enter the system when the first control valve 38 is deactivated. The second control valve 40 has its exhaust port going to atmosphere, to permit atmospheric pressure air to enter the system when the second control valve 40 is deactivated. The control valves 38, 40 are controlled by a control switch 44, that is also located in the control box 36.

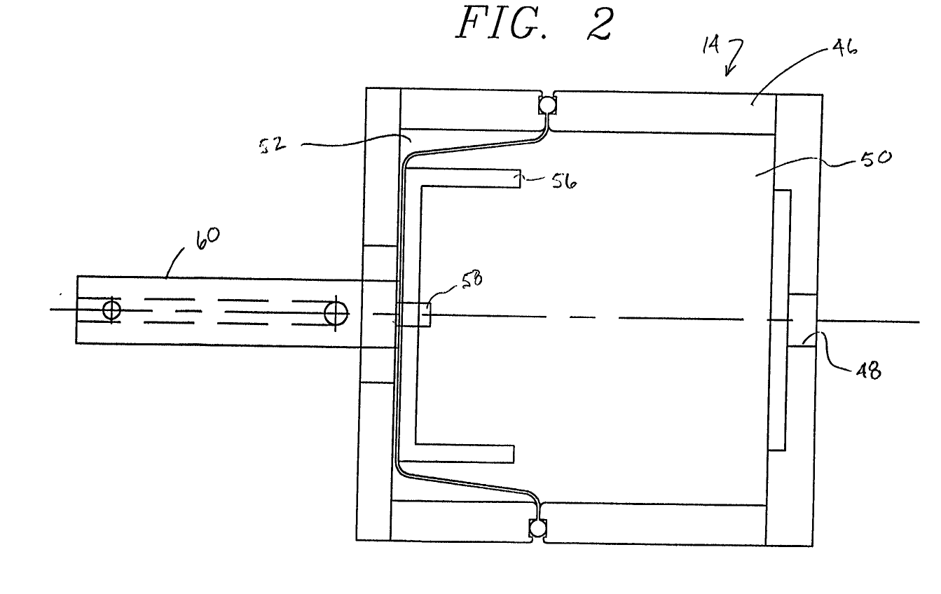

The control box 36 is connected to the vacuum motor 14 with another air hose. A detailed view of the vacuum motor 14 is shown in FIG. 2. The vacuum motor 14 includes a rigid air tight outer shell 46 with an inlet port 48. A flexible membrane 54 seals the vacuum motor interior into two portions, a vacuum side 50 and a brake side 52. A mounting plate 56 on the vacuum side 50 of the flexible membrane receives a stem 58 that extends from rod 60. Rod 60 is connected to cable 62, which goes through the firewall 64 of the towed vehicle 10. A vacuum motor 14 is believed to be superior to other methods of depressing the brake pedal 16. Vacuum motors are robust and less likely to suffer leaks than air piston and cylinder arrangements.

The flexible cable 62, runs through a diverter sheave 66 that is mounted on the interior of the firewall 64. As best seen in FIG. 7, a mounting plate 65 is provided to mount the diverter sheave 66 to the firewall 64. The cable 62 has a brake pulling bracket 68 that attaches to the arm 17 of the brake pedal 16. The diverter sheave 66 is basically a wheel that redirects the direction of the cable 62 so that it can pull the brake pedal 16. A diverter sheave mounting bracket 67 attaches the diverter sheave 66 to the mounting plate 65, which bolts to the firewall.

The electrical components of the system can also be seen schematically in FIG. 1. In normal use, the electrical energy for the system is provided by the battery of the towing vehicle 12. Those of ordinary skill in the art will understand that a separate source of electrical energy could be provided. The wiring for the system is identified by conventional colors. Obviously it will not be necessary for the wires to be of any particular color; however, the color scheme described herein is useful for identifying the wires, but may be varied in practice. The cold side of the towing vehicle's brake light switch 74 is wired to an on-off switch that can be manually moved between the on (closed) position and the off (open) position. A red wire 72 runs from the cold side of the on-off switch to a terminal 76 at the rear of the towing vehicle 12. A standard wiring kit 78 connects the wires at the terminal of the towing vehicle with a similar terminal 80 at the front of the towed vehicle 10.

From the front of the towed vehicle 10, the red wire 72 connects to a terminal on the second control valve 40, which acts as the on-off valve for the braking system. Therefore, when the brakes on the towing vehicle 12 are applied, and the towing vehicle brake light switch 74 is thereby closed, the second control valve 40 is activated. The red wire 72 is also connected to the control switch 44. The control switch 44 is normally in a closed position, and is wired to the first control valve 38. The control switch 44 is pressure sensitive, and moves to the open position when the pressure in the air hose leading to the vacuum motor 14 drops below a specified level. The amount of pressure required to maintain the control switch 44 in the closed position can be adjusted by turning a screw that is accessible through the case of the control box 36. Therefore, when the brakes on the towing vehicle 12 are applied and the brake light switch 74 is thereby closed, the first control valve 38 is activated, unless the pressure in the vacuum motor 14 is below a specified level. The first control valve 38 thereby acts as a regulator to only apply depress the towed vehicle brake pedal 16 a desired percentage, rather than fully depressing the pedal in most braking instances.

A white wire 110 runs from the negative terminal of the towing vehicle battery 70 to the negative terminal of the towed vehicle batter 86. The white wire 110 then runs to both the first control valve 38 and the second control valve 40.

In certain instances, such as “panic stops” or break away situations, it is desirable to fully apply the brakes of the towed vehicle 10. The wiring of the system permits full application of the towed vehicle 10 brakes in these situations. The red wire 72 is also wired to a momentum switch 82. The momentum switch 82 is wired to the first control valve 38, and is normally open, but closes when it senses a fast change in momentum in the towed vehicle 10. The momentum switch 82 is typically a gravity switch, such as a mercury switch, but those of ordinary skill in the art will be aware of other acceptable alternatives. Therefore, in instances where the towed vehicle 10 is slowing so rapidly that the momentum switch 82 closes, the momentum switch 82 overrides the control switch 44, and activates the first control valve 38 even if the control switch 44 is open, so that the full vacuum created by the vacuum source 18 is applied to the vacuum motor 14.

The wiring is also structured to apply the towed vehicle brakes in a break away situation where the towed vehicle 10 has become accidentally unhitched from the towing vehicle 12 during the towing process. An orange wire 84 connects the positive terminal of battery 86 of the towed vehicle 10 to a break away switch 88 that is held open by a pin 90 connected to a break away cable 92 that attaches to the rear of the towing vehicle 12. These break away switches are common, and several designs will work effectively with the present system. The cold side of the break away switch 88 is wired by a black wire 96 to the first control valve 38. The cold side of the break away switch 88 is also wired to the second control valve 40, across a diode 94. The diode 90 prevents back current to the first control valve 38 when the break away switch 88, momentum switch 82, and control switch 44 are all open and the towing vehicle brakes are being applied.

The wiring of the system also allows for monitoring and testing of the status of the system in several regards. A test switch 98 can be wired to the battery 70, or other power source, on the towing vehicle 12. This test switch 98 normally is open, but can be closed to simulate the application of brakes in the towing vehicle 12. The cold side of the test switch 98 is wired to the red wire 72 to bypass the on-off switch 74. A power indicator light 100 is wired on one terminal to the cold sides of both the on-off switch 74 and test switch 98, and on the other terminal to ground, or the negative terminal of the towing vehicle battery 70. Therefore, when braking system in the towed vehicle 10 is receiving power is going from the towed vehicle 12, the power indicator light 100 is lit.

A towed vehicle brake status indicator light 102 is also provided in the towing vehicle 12. A blue wire 104 connects the towed vehicle brake status indicator light with the cold side of the brake light switch 106 of the towed vehicle 10. Therefore, anytime the brakes of the towed vehicle 10 are applied, such that the brake lights of the towed vehicle are activated, the towed vehicle brake status indicator light 102 is also lit. Typically, both the towed vehicle brake status indicator light 102 and the power indicator light 100 are mounted in the cabin of the towing vehicle 12, in plain sight of the driver of the towing vehicle 12 so that the driver can monitor the status of the system.

A break away test switch 108 is also provided to permit testing of the break away function. The break away test switch 108 is typically mounted in the cabin of the towed vehicle 10, but may also be mounted under the hood of the towed vehicle 10. The cold side of the break away test switch 108 is wired to the black wire 96, while the hot side of the break away test switch 108 is wired to the orange wire 84. The break away test switch 108 is normally in an open position, but can be manually adjusted to a closed position to test whether the break away function is operational. If the system is operational, the brake pedal 16 of the towed vehicle 10 should be fully applied when the test switch 108 is moved to a closed testing position.

Those of ordinary skill in the art will be aware of various options for mounting the components described above on the towed 10 and towing 12 vehicles. A preferred manner of mounting the components is described below. The first step is to disconnect the battery 86 of the towed vehicle, so that no accidental electrocution will occur. The control box 36, vacuum motor 14, and vacuum reservoir 34 should be mounted under the hood of the towed vehicle. It is important that these items be mounted in locations such that they are not resting against any hot engine components and that they be located so that they can be adjusted. These components may be preferably mounted with self-tapping screws.

If the momentum switch 82 is a gravity switch, such as a mercury switch, it must be mounted in the proper orientation. Typically, this will mean that the momentum switch will be mounted on one of the outer walls of the engine compartment of the towed vehicle such that the wire outlet end of the momentum switch 82 points towards the front of the towed vehicle 10. The momentum switch must be at the proper angle with respect to level in order to function properly. To help accomplish this, a tool 112 is provided that has a two opposing surfaces offset from each other by the proper angle of orientation for the momentum switch 82. To properly orient the momentum switch 82, the tool 112 is placed with one of the surfaces on the momentum switch 82. A level 116 can then be placed on the opposing surface to verify that the momentum switch 82 is mounted at the proper angle. Preferably, the side of the tool 112 placed on the momentum switch 82 will have a cut-out area 114 to allow for the mounting bracket 83 of the momentum switch 82.

A standard mounting bracket should be mounted to the front of the towed vehicle 10 to permit quick connection of the wires and the vacuum line 20. This mounting bracket should include the quick coupling 22 as well as a wire receptacle to act as the 80. Additionally, the break away switch 88 should be mounted to the front of the towed vehicle 10. This is a standard arrangement for which those of ordinary skill in the art will be aware of numerous alternatives.

The diverter sheave 66 needs to be mounted to cabin side of the firewall 64. This is accomplished by pulling back the carpet on the floor pan of the driver's side of the towed vehicle 10. The battery 86 should be temporarily reconnected for this step, because it will be necessary to start the towed vehicle 10 and apply its brakes. The mounting plate 65 should be mounted directly underneath the brake pedal 16. The mounting plate 65 can then be mounted the floor pan, and the carpet reapplied over the top of the mounting plate 65. A small hold should be trimmed in the carpet to permit an allen bolt provided at the center of the mounting plate 65 to extend upwardly through the carpet. The diverter sheave mounting bracket 67 is then mounted to this allen bolt to connect the diverter sheave mounting bracket to the mounting plate 65. The brake cable 62 should be fed through the firewall 64 of the towed vehicle 10. This can usually be accomplished through the auxiliary wire boot provided in most vehicles. The cable 62 should be threaded through the diverter sheave 66, and attached to the brake pulling bracket 68. The brake pulling bracket 68 should be attached to the brake pedal arm 17, as close as possible to the brake pedal 16. The opposite end of the cable 62, should then be connected with the rod 60 of the vacuum motor 14.

The break away test switch 108 should be mounted on the interior of the towed vehicle 10, commonly under the dash. The orange wire 84, and the black wire 96 should be threaded through the rubber auxiliary wire boot, and connected to the break away test switch.

The blue wire 104 should be connected to the cold side of the towed vehicle brake light switch 106. A brake light relay may be used for this purpose. Those of ordinary skill in the art will be well aware of different manners for attaching the blue wire 104 to the cold side of the towed vehicle brake light switch.

The towed vehicle battery 86 can be reconnected, and the break away system can be tested and calibrated. To calibrate the system, a level area with no traffic, preferably a large vacant parking lot, should be used. The towed vehicle 10 should be started and driven, free from the towing vehicle 12, at a speed of approximately twenty miles per hour. The test switch is then moved to the activated or closed position. The system should depress the towed vehicles brakes, and bring the vehicle to a stop within forty feet. If the vehicle travels more than forty feet before stopping, the effective length of cable 62 needs to be shortened slightly. If the vehicle stops more quickly than forty feet it will be necessary to lengthen the effective length of cable 62. Those of ordinary skill in the art will be aware of various methods of adjusting the effective length of the cable 62.

For gas powered towing vehicles 12 the preferred vacuum is the intake manifold of the engine. For gas powered vehicles, a vacuum hose 20a should be connected directly to an intake vacuum port on the towing vehicle's engine. For diesel powered towing vehicles 12, an auxiliary vacuum pump should be installed. Those of ordinary skill in the art will be well aware of various types and models of vacuum pumps that are suitable. It has been found that a vacuum pump that will create a vacuum of approximately twenty-one inches of mercury should be sufficient.

Preferably, the on-off switch 74, the test switch 98, and the indicator lights 100, 102 are mounted together on a power switch panel that can be mounted to the interior of the towing vehicle 12. This should be mounted in a location that is easily visible and accessible to a driver of the towing vehicle.

The on-off switch should be wired to the cold side of the brake light switch 74 of the towing vehicle. Those of ordinary skill in the art will be familiar with how to do this. One such manner is to find the cold side of the brake light switch 74 by using a wire tester and find the wire that lights the tester only when the brake pedal is depressed. The wire can then be cut, and both cut ends of the wire stripped, and then the stripped ends of the cut wire can be connected to the on-off switch using butt connectors.

The indicator lights 100 and 102, and the test switch 98 are then wired according to the structure described above so that the system should be fully operational. When connecting the test switch 98, it is important to be sure that the wire to which it is connected has power only when the ignition key is turned on, and does not have power when the ignition key is turned off. This is typically available through an auxiliary power source outlet in the fuse panel of the towing vehicle 12.

To operate the system, it is necessary to hitch the towed vehicle 10 to the towing vehicle 12, typically with a tow bar. An air hose 20b is then used to connect the quick connect couplings 22a and 22b. A wiring kit 78 is used to join all of the electrical connections between the two vehicles. The break away cable 92 should be attached in place between the break away switch 88 at the front of the towed vehicle 10 and the rear of the towing vehicle 12. The brake pulling bracket 68 should be attached to the brake pedal arm 17. The towing vehicle 12 should be started, and the on-off switch 74 adjusted to the on position. It may be desirable to test the system by adjusting the break away test switch 108 to the on position to make sure the brake pedal 16 is depressed. Similarly, it make be a good idea to test the system by adjusting the test switch 98 to the on position to see if the brakes on the towed vehicle 10 get applied.

To determine whether the control switch 44 is set to the right pressure, a few stops should be made while pulling the towed vehicle 10 behind the towing vehicle 12 with the system engaged. If the brakes of the towed vehicle 10 are cold, then the pressure setting for the control switch 44 may be set too high, such that the switch opens too soon before the vacuum reaches a high enough level to apply the brake pedal 16 as strongly as desired. Alternatively, if the brakes of the towed vehicle 10 are hotter than the brakes of the towing vehicle 12, then the pressure may be set too low, and the brake pedal 16 of the towed vehicle 10 is being pulled too far during normal stopping. Appropriate adjustment should be made.

When the brakes of the towing vehicle 12 are applied, that closes the brake light switch 74 on the towing vehicle 12. Power is thereby control valves 40 and 38, and they are activated to apply vacuum from the vacuum source 18 to the vacuum motor 14. As the vacuum is applied to the vacuum motor, the vacuum motor 14 pulls cable 62, which depresses the brake pedal 16. When vacuum builds to a sufficient level, the control switch opens, which deactivates the first control valve 38 and breaks the pneumatic connection between the vacuum motor 14 and the vacuum source 18. However, the vacuum that existed on the vacuum motor before the deactivation of the first control valve 38 remains constant because the exhaust port on the first control valve 38 is closed. When the brakes on the towing vehicle 12 are released, the brake light switch 74 on the towing vehicle 12 opens, and the second control valve 40 is also deactivated. The exhaust port on the second control valve goes to atmosphere, so the vacuum motor releases its pull on the brake pedal 16, and the brakes on the towed vehicle 10 are no longer applied. In this manner, the brakes on the towed vehicle 10 are applied and released almost instantaneously with the brakes of the towing vehicle 12. However, the brakes on the towed vehicle 10 are only partially applied to avoid unduly straining the brakes on the towed vehicle or causing skidding or pulling by the towed vehicle 10.

In the panic mode, when the momentum switch 82 closes, the both control valves 38, 40 are maintained in the activated position, regardless of whether the control switch 44 is open. In this manner, the regulated partial pull of the brake pedal that occurs in a typical application of the brakes is bypassed so that the full braking force can be applied.

The panic mode of stopping the vehicle should not occur too early or too late. If the panic mode is engaged too early it can result in skidding of the towed vehicle. If the panic mode is engaged too late, it is not effective in helping to quickly bring both the towing vehicle 12 and towed vehicle 10 to a quick stop. To test for this, the towing vehicle 12 should fully apply its brakes while pulling the towed vehicle 10. If the towed vehicle 10 lock or slide during this process, then the panic mode is being engage too early and the angle of the momentum switch 82 should be adjusted by raising the front end of the momentum switch 82. If, on the other hand, the towing vehicle 12 and towed vehicle 10 are brought to a complete stop before the system goes into full braking, then the momentum switch should be adjusted lowering the front end of the momentum switch 82 so that it will be triggered more easily.

In a break away situation, the breakaway cable 92 will remain attached to the towing vehicle 12, and the pin 90 will be removed from the break away switch 88. The break away switch 88 will therefore close, which will complete a circuit that activates both of the control valves 34, 40. The vacuum stored in the vacuum reservoir 34 will activate the vacuum motor 14 and thereby depress the brake pedal 16. The check valve 30 prevents back flow of air into the system. The reservoir 34should hold the brake pedal 16 depressed for at least fifteen minutes following a break away.

Therefore, what has been described is a system that provides supplemental braking power to a towed vehicle by utilizing the brake booster 26 of the towed vehicle 10. The brakes of the towed vehicle 10 will only partially be deployed in standard braking situations. This permits greater control of the towed vehicle 10, avoids unnecessary wear on the brake parts as compared to systems that fully employ the towed vehicles brakes 10 in every situation. Furthermore, the system provides the advantage of fully applying the towed vehicle 10 brakes in situations where that is important, such as a break away or a panic stop. The use of a vacuum motor having a flexible membrane provides a robust and effect means of applying the towed vehicle's brakes.

What is claimed is:

1. An apparatus for applying the brakes on a towed vehicle being pulled by a towing vehicle, the towed vehicle having a braking system activated by depressing a brake pedal, the towing vehicle having a source for supplying a vacuum, the apparatus comprising:
a vacuum motor having a flexible membrane movable by application of a vacuum;
a pneumatic circuit operably connecting said vacuum motor to the source for supplying a vacuum;
a mechanical connection between said membrane and the brake pedal such that as said membrane is moved from a rest position by application of a vacuum, said mechanical connection depresses the brake pedal;
a control valve in said pneumatic circuit, said control valve having an activated position wherein said vacuum source is placed in pneumatic connection with said vacuum motor, and a deactivated position wherein said vacuum source is diverted from said vacuum motor; and
a means for selectively moving said control valve between said activated and deactivated positions.

2. The apparatus of claim 1, further including a regulator valve in said pneumatic circuit, said regulator valve being located between said control valve and the vacuum source, said regulator valve being movable between an activated position wherein said vacuum source is placed in pneumatic connection with said vacuum motor and a deactivated position wherein said vacuum source is diverted from said vacuum motor, said apparatus further comprising a means for selectively moving said regulator valve to said deactivated position when a pressure level in said pneumatic circuit drops below a specified minimum pressure level.

3. The apparatus according to claim 2, wherein said control valve and said regulator valve are both two-position three-way valves.

4. The apparatus according to claim 3, wherein said control valve exhausts to atmosphere and said regulator valve has an exhaust port that is closed to prevent atmospheric air from entering said pneumatic circuit when said control valve is in said deactivated position.

5. The apparatus according to claim 1, further comprising a connection between the source for supplying a vacuum and a vacuum brake booster on the towed vehicle, such that the source for supplying a vacuum can provide a vacuum to said vacuum brake booster and thereby provide decrease the amount of force required to depress the brake pedal.

6. An apparatus for controlling the amount of force used to depress a brake pedal of a towed vehicle in a supplemental braking system for use in providing a braking force to the towed vehicle being pulled behind a towing vehicle, the supplemental braking system being of the type that utilizes a vacuum force from a vacuum source to create a pull force to depress the brake pedal, said apparatus comprising: said activated position permitting said vacuum force to be applied to said brake pedal;
a regulator valve, said regulator valve having an activated position and a deactivated position, said activated position of said regulator valve permitting said vacuum force to be applied to said brake pedal, said deactivated position of said regulator valve diverting said vacuum force from said brake pedal, but maintaining said pulling force on said brake pedal; and
means for moving said regulator valve to said deactivate position when said vacuum force reaches a desired level.
